(19) United States
(12) Patent Application Publication
(10) Pub. No.: US 2008/0037514 A1
(43) Pub. Date: Feb. 14, 2008

(54) METHOD, SYSTEM, AND COMPUTER PROGRAM PRODUCT FOR CONTROLLING A VOICE OVER INTERNET PROTOCOL (VOIP) COMMUNICATION SESSION

(75) Inventors: Brian D. Goodman, Norwalk, CT (US); Frank L. Jania, Chapel Hill, NC (US); Darren M. Shaw, Hampshire (GB)

Correspondence Address: CANTOR COLBURN LLP - IBM TUSCON DIVISION, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/426,720

(22) Filed: Jun. 27, 2006

(51) Int. Cl. H04L 12/66

(52) U.S. Cl. 370/352

(57) ABSTRACT

A method, system, and computer program product for controlling a VoIP communication session is provided. The method includes accessing user-defined settings for a live VoIP communication session representing a first audio stream between at least two parties. The method includes recording the live VoIP communication session resulting in a second audio stream and generating a timeline representing the first and second audio streams. The method further includes displaying the timeline to one of the two parties who is identified in the user-defined settings. The method also includes monitoring the first audio stream for the occurrence of a trigger event specified via the user-defined settings. The method also includes marking the timeline with an indicator representing the occurrence of the trigger event. The method further includes presenting user-selectable control options for modifying presentation of the second audio stream, which are implemented by selection of markings on the timeline and playback controls.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to communications, and particularly to a method, system, and computer program product for controlling a voice over Internet protocol (VoIP) communication session.

2. Description of Background

A traditional voice channel as implemented in the telephone network provides a synchronous form of communication. Other communications technologies, e.g., VoIP, mimic the operation of the traditional telephone. VoIP communications provide routing of voice conversations over the Internet or through other IP-based networks (e.g., local area network, wide area network, etc.).

Both of these communications channels offer little control over the communications session for the parties at either end of the conversation. For example, if a listening party becomes temporarily distracted and misses a portion of the conversation, there are no means by which the listening party can re-capture the missed portion. Multitasking while on a phone call is very common and can be quite counter-productive when key portions of the conversations have been missed.

What is needed, therefore, is communications tool that allows blended synchrony in voice conversations that includes user-selectable features for providing control over the interaction within the conversation.

### SUMMARY OF THE INVENTION

The shortcomings of the prior art are overcome and additional advantages are provided through the provision of a method, system, and computer program product for controlling voice over Internet protocol (VoIP) communication sessions. The method includes accessing user-defined settings for a live VoIP communication session representing a first audio stream between at least two parties. The method includes recording the live VoIP communication session resulting in a second audio stream and generating a timeline representing the first and second audio streams. The method further includes displaying the timeline to one of the two parties who is identified in the user-defined settings. The method also includes monitoring the first audio stream for the occurrence of a trigger event specified via the user-defined settings. The method also includes marking the timeline with an indicator representing the occurrence of the trigger event. The method further includes presenting user-selectable control options for modifying presentation of the second audio stream, which are implemented by selection of markings on the timeline and playback controls.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution that allows blended synchrony in voice conversations, such that parties to these conversations control presentation of the communications session via user-selectable control features.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a system upon which communication session control features may be implemented in exemplary embodiments;

FIG. 2 illustrates one example of a flow diagram describing a process for implementing the communication session control features in exemplary embodiments;

FIG. 3 illustrates one example of a user interface screen for use in implementing the communication session control features in exemplary embodiments; and

FIG. 4 illustrates another example of a user interface screen for use in implementing the communication session control features in exemplary embodiments.

The detailed description explains the preferred embodiments of the invention, together with advantages and features, by way of example with reference to the drawings.

### DETAILED DESCRIPTION OF THE INVENTION

In accordance with exemplary embodiments, communication session control processes are provided. The communication session control processes are implemented by a communications tool that allows blended synchrony in voice conversations by enabling interactive control over the communications session.

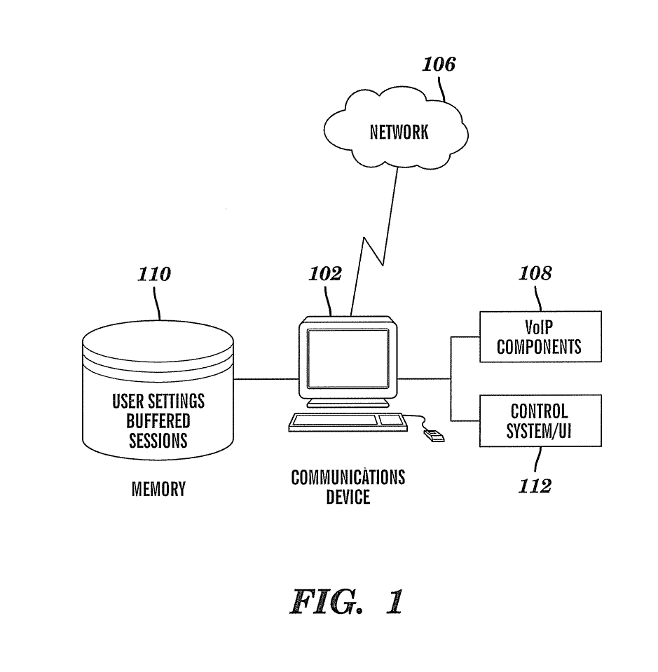

Turning now to FIG. 1, a system 100 for implementing the communication session control processes in exemplary embodiments will now be described. In exemplary embodiments, the system 100 of FIG. 1 includes communications device 102 in communication with a network 106 through which communication sessions between devices are facilitated. The communications device 102 may be any type of IP-enabled communications device, such as a personal computer, laptop, or similar type of device. In exemplary embodiments, network 106 is an Internet Protocol-enabled network system that routes packets of data to and from devices, such as communications device 102. Network 106, e.g., may be an integrated inter-network system, such as the Internet, or other type of network, such as a local area network, wide area network, etc.

The communications device 102 includes, or is communicatively coupled to, Voice over IP components 108 for communicating with third party devices over network 106. For example, Voice over IP components 108 may include a standard analog telephone that is coupled to a router/adapter, which in turn is in communication with, e.g., a hub/switch and the communications device, as well as a digital subscriber line (DSL) or broadband modem. The modem links the aforementioned elements to the Internet or other IP-based network, e.g., network 106.

In alternative embodiments, the VoIP components 108 may include a soft phone (e.g., communications software installed on the communications device 102) and a headset that plugs into a port of the communications device 102. In further embodiments, the VoIP components 108 may include a wireless fidelity (WiFi) SIP phone. Other input/output elements that may be included in the communications device 102 are speakers, microphone, sound card, display monitor, etc. One or more of the VoIP components 108 receive analog voice signals from a user of the communications device 102 during a communications session and convert the analog voice signals into digital signals (packets) for transmission over an IP-based network, such as network 106. Likewise, incoming digital packets received by the VoIP components 108 from network 106 are converted into analog voice signals for presentation to the user of the communications device 102. All or a portion of these VoIP components 108 may comprise proprietary products or may be commercial tools.

Thus, implementation of a live VoIP communications session is facilitated by the VoIP components 108, which transmit converted analog-to-digital signals over the network 106 and also present converted digital-to-analog signals received from the network 106 to a user of the communications device 102.

VoIP components and communications may be enabled using a variety of communications protocols, e.g., Session Initiation Protocol (SIP), Inter-Asterisk exchange (LAX), H.323, etc., depending upon the particular type of VoIP components utilized.

In exemplary embodiments, communications device 102 also includes memory (internal or external) for storing information, such as user settings and communications session recordings as described further herein.

The communication session control processes are implemented via a control system application and user interface 112 executing on the communications device 102. The control system application and user interface 112 monitors communications sessions between two or more parties, creates a timeline recording of the sessions, executes user settings, generates alerts, and presents modified communications sessions to the user of the communications device 102.

In accordance with exemplary embodiments, the user settings are established via the user interface of the control system application 112 and are executed by the control system application 112. The user interface of the control system application 112 also enables the user to select one or more controls for modifying the presentation of the communications session. These, and other features are described further herein.

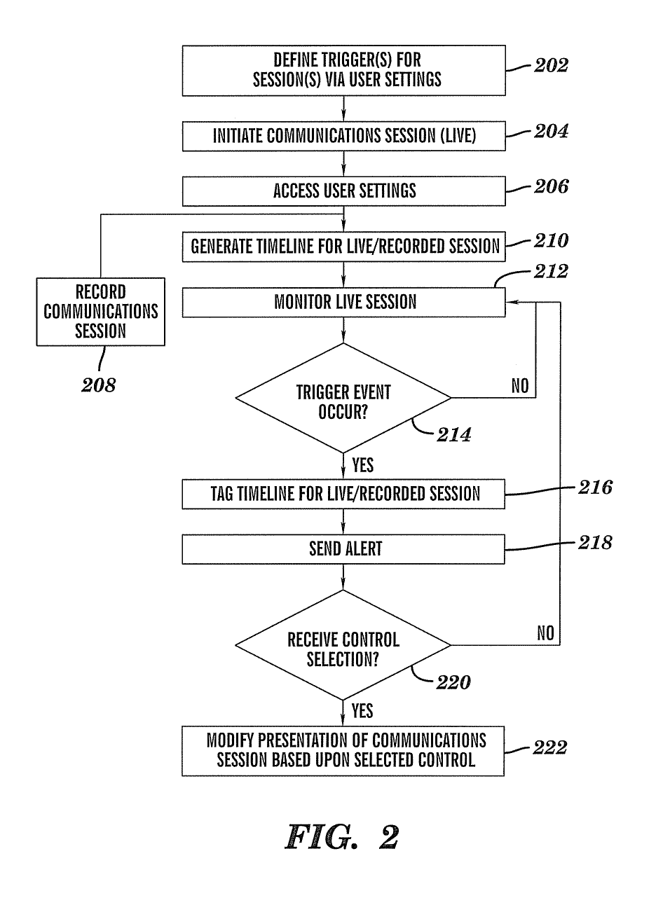

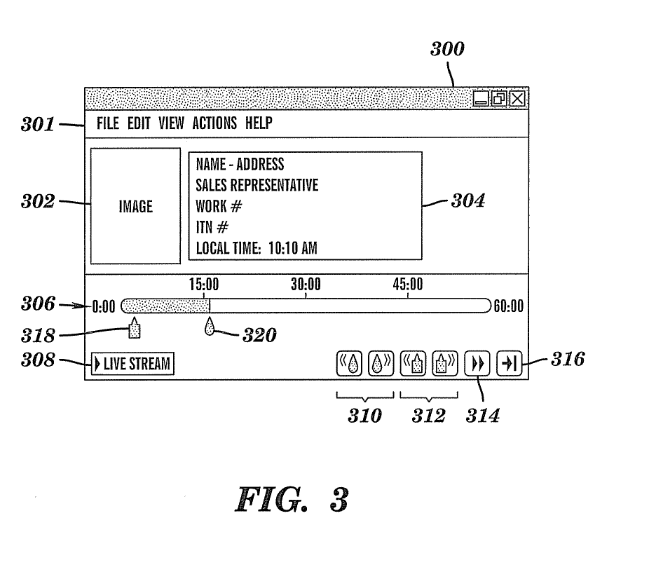

Turning now to FIG. 2, a flow diagram describing a process for implementing the communication session control features will now be described in accordance with exemplary embodiments. At step 202, a user of communications device 102 establishes individual preferences via the user interface of the control system application 112. A sample user interface screen 300 is shown in FIG. 3. The user may establish these preferences, e.g., via a toolbar 301 presented by the user interface. These settings may be stored in memory 110 of the communications device 102.

The individual preferences include triggers that define events, the occurrence of which during the communications session will cause an alert to be generated by the control system application 112. The alerts are presented to the user at communications device 102. These triggers may be established on a session-by-session basis or may be applied globally to all sessions as desired. For example, an event may be an extended or elapsed period of silence during the communications session (i.e., no one speaking). The user may define what is to be considered ‘extended’ via the user preferences, e.g., one, five, ten minutes, etc. In another example, an event may be a change in speaker, a particular sound (e.g., bell tone), etc. that may serve as a trigger for an alert. This type of event may be determined using a key sound identification component of the control system application 112 that implements one or more functions, such as automated speech recognition, audio feature detection, audio indexing, keyword spotting, speaker and language identification, etc. The key sound identification component of the control system application 112 monitors the communications session and detects any changes or events using one or more of the aforementioned functions. The above are provided as non-limiting examples of trigger events and are not to be construed as limiting in scope.

At step 204, a live VoIP communications session between the user of communications device 102 and another device (not shown) over network 106 is initiated (e.g., a first audio stream). As described above in FIG. 1, the VoIP components 108 convert the analog signals received from the user of the communications device 102 into digital signals for transmission over network 106. The VoIP components 108 likewise, convert the digital signals received over the network 106 to analog signals for presentation to the user of the communications device 102. These back-and-forth communications form the communications session, which continues until one of the parties to the session disconnect the communication. As indicated above, the transmission of these signals between parties to the communications session is provided in real-time, i.e., live audio stream. As shown in the user interface screen 300 of FIG. 3, various information elements are provided during the communication session. For example, an image of a party 302 on the other end of the communications session may be displayed. In addition, identifying information 304 about the party may be presented. An indicator 308 within the user interface screen 300 informs the user that the communications session presented is a live audio stream.

At step 206, the control system application 112 accesses the user settings defined in step 202. The communications session is recorded by the control system application 112 at step 208 to produce a second audio stream. A timeline of the communications session is generated by the control system application 112 that captures the live/recorded communications session at step 210. This timeline may be represented as a graphical or pictorial timeline of the session, which may be stored in memory 110 of the communications device 102 and presented via, e.g., a user interface, such as the user interface screen 300 of FIG. 3.

The live communications session is monitored by the control system application 112 at step 212. The control system application 112 monitors the live audio stream for trigger events (e.g., extended periods of silence, key sound indicators, etc.). At step 214, it is determined whether a trigger event has occurred. If not, the monitoring continues at step 212. Otherwise, if a trigger event has occurred, the control system application 112 tags the timeline with an indicator that corresponds to the nature of the event. As shown in FIG. 3, for example, a square shape 318 is used to indicate an extended silence event, while a teardrop shape 320 is used to indicate a key sound event.

The occurrence of these trigger events causes the control system application 112 to generate and transmit an alert to the user of the communications device 102 at step 218. This alert may be useful in suggesting that the user, e.g., refocus attention on the session (for extended silence events) or to identify specific locations of the session timeline for use in implementing selectable control features of the communication session control processes.

As shown in the user interface screen 300 of FIG. 3, an extended period of silence event occurred in the session as evidenced by a square indicator 318. In addition, a key sound event occurred in the session as evidenced by a teardrop indicator 320 on timeline 306.

At step 220, it is determined whether the control system application 112 has received a control selection from the user. The control features available via the communications session control processes include skipping forward or backward from one silence indicator on the timeline to the next, speeding up playback of a portion of a buffered (i.e., recorded) communications session, and skipping to the end of a recorded communications session in order to rejoin the live communications session. As shown in the user interface screen 300 of FIG. 3, e.g., a set of control features 310 is provided for moving backwards and forward, respectively between key sound indicators tagged on the timeline 306. In addition, a set of control features 312 are provided for moving backwards and forward, respectively between extended silence indicators on the timeline 306. A speed playback control 314 is provided by the user interface screen 300 for presenting playback of the communications session, or a selected portion thereof, at a fast speed (e.g., 2× normal speed). A move-to-end control 316 is provided by the user interface screen 300 for jumping forward to the end of the recorded communication session so that the user may rejoin the live communication session. It will be understood that the control selection query of step 220 may be implemented multiple times during a communications session.

If no control selection has been received at step 220, the process returns to step 212 whereby the live session continues to be monitored. If, however, a control selection has been received, the control system application 112 modifies the presentation of the communications session for the user based upon the control (e.g., 310-316) selected at step 222.

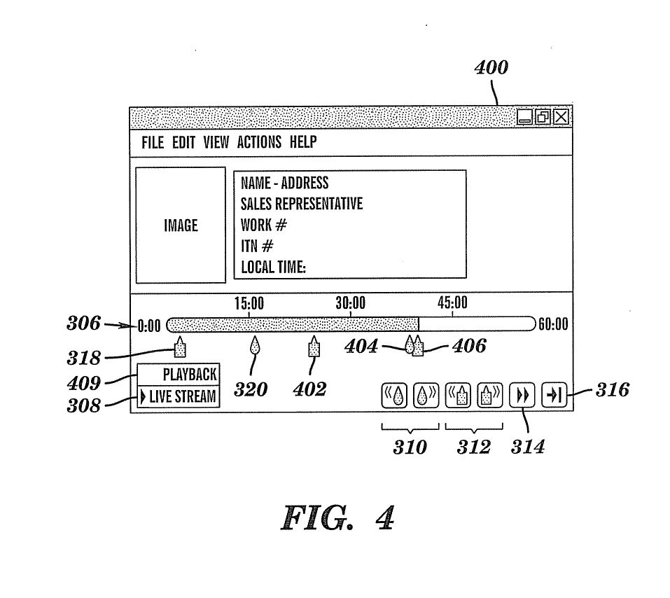

For example, as shown in a user interface screen 400 of FIG. 4, a communications session has been in progress for over 40 minutes. For purposes of illustration, it is assumed that the user desires to catch up on a portion of the session that was missed. This may be implemented in two ways. First, the user may select one of the extended time indicators 318 or 402, or may select one of the key sound indicators 320 or 404, any one of which will determine a point in the session (e.g., a marking of an event on the timeline 306) to begin playback. Alternatively, the user may select a control from one of control sets 310, 312.

In alternative embodiments, the control system application 112 includes an automated feature whereby a user instructs the application 112 to automatically jump back to the time of a key sound indicator (e.g., 404) when a trigger established for an extended period of silence (e.g., 406) has been detected. This feature may include returning to a portion of the session preceding the key sound indicator.

The control system application 112 accesses the corresponding location in the communications session (or a determined offset thereof) and enters playback mode. The playback mode may be presented at a faster speed than that of the original session. A default playback speed may be determined by the control system application 112 if the user does not select a speed. This allows the user to listen to the conversation in less time.

Once the playback mode has been selected, two audio streams are played at the communications device (i.e., the first, or live, audio stream of the communications session; and the second, or recorded, audio stream). As shown in the user interface screen 400 of FIG. 4, a playback indicator 409 is shown overlapping the live stream indicator 308 indicating that the user is in playback mode. The control system application 112 gives aural precedence to the overlapping indicator (in this case, playback mode 409) which includes presenting the playback recording at a higher volume than that of the live audio stream. The user may switch between playback mode and live audio stream by selecting the appropriate indicator (i.e., one of 308, 409) which would, in turn, switch the aural precedence given. Once the playback mode has been exhausted, the live audio stream would become the sole audio stream and its volume would be adjusted to its standard level.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for controlling a voice over Internet protocol (VOIP) communication session, comprising:
accessing user-defined settings for a live VoIP communication session between at least two parties, the live communication session representing a first audio stream;
recording the live VoIP communication session resulting in a second audio stream;
generating a timeline representing the first and second audio streams;
displaying the timeline to one of the at least two parties who is identified in the user-defined settings via a display on a communications device;
monitoring the first audio stream for the occurrence of a trigger event specified via the user-defined settings, wherein trigger events include a period of elapsed silence in the first audio stream and a key sound;
marking the timeline with an indicator representing the occurrence of the trigger event when the trigger event occurs, wherein a silence indicator is applied to the timeline for a trigger event reflecting the period of elapsed silence and a key sound indicator is applied to the timeline reflecting the key sound; and
presenting user-selectable control options for modifying presentation of the second audio stream, the user-selectable control options implemented by selection of markings on the timeline and playback controls.

2. The method of claim 1, further comprising:
sending an alert to one of the at least two parties who is identified in the user-defined settings when the trigger event occurs, wherein the modifying presentation of the second audio stream is performed in response to a control option selected as a result of the alert.

3. The method of claim 1, wherein the presentation of the second audio stream is modified by at least one of:
jumping forward or backward between key sound indicators;
speeding up playback of a portion of the second audio stream;
jumping to the end of the second audio stream and rejoining the first audio stream in progress; and
automatically returning to a portion of the second audio stream when a trigger set for the period of elapsed silence has been detected.

4. The method of claim 1, wherein the key sound includes at least one of:
a change of speaker, wherein the speaker represents one of the at least two parties; and
an audio tone.

5. A system for controlling a voice over Internet protocol (VoIP) communication session, comprising:
a VoIP-enabled communications device, the VoIP communications device including a computer processor; and
a control system application executing on the communications device, the control system application implementing:
accessing user-defined settings for a live VoIP communication session between at least two parties, the live communication session representing a first audio stream, and the user-defined settings established via a user interface of the control system application;
recording the live VoIP communication session resulting in a second audio stream;
generating a timeline representing the first and second audio streams;
displaying the timeline to one of the at least two parties who is identified in the user-defined settings via a display on the communications device;
monitoring the first audio stream for the occurrence of a trigger event specified via the user-defined settings, wherein trigger events include a period of elapsed silence in the first audio stream and a key sound;
marking the timeline with an indicator representing the occurrence of the trigger event when the trigger event occurs, wherein a silence indicator is applied to the timeline for a trigger event reflecting the period of elapsed silence and a key sound indicator is applied to the timeline reflecting the key sound; and
presenting user-selectable control options for modifying presentation of the second audio stream on the display, the user-selectable control options implemented by selection of markings on the timeline and playback controls.

6. The system of claim 5, wherein the control system application further implements:
sending an alert to one of the at least two parties who is identified in the user-defined settings when the trigger event occurs, wherein the modifying presentation of the second audio stream is performed in response to a control option selected as a result of the alert.

7. The system of claim 5, wherein the presentation of the second audio stream is modified by at least one of:
jumping forward or backward between key sound indicators;
speeding up playback of a portion of the second audio stream;
jumping to the end of the second audio stream and rejoining the first audio stream in progress; and
automatically returning to a portion of the second audio stream when a trigger set for the period of elapsed silence has been detected.

8. The system of claim 5, wherein the key sound includes at least one of:
a change of speaker, wherein the speaker represents one of the at least two parties; and
an audio tone.

9. A computer program product for controlling a voice over Internet protocol (VoIP) communication session, the computer program product including instructions for executing a method, comprising:
accessing user-defined settings for a live VoIP communication session between at least two parties, the live communication session representing a first audio stream;
recording the live VoIP communication session resulting in a second audio stream;
generating a timeline representing the first and second audio streams;
displaying the timeline to one of the at least two parties who is identified in the user-defined settings via a display on a communications device;
monitoring the first audio stream for the occurrence of a trigger event specified via the user-defined settings, wherein trigger events include a period of elapsed silence in the first audio stream and a key sound;
marking the timeline with an indicator representing the occurrence of the trigger event when the trigger event occurs, wherein a silence indicator is applied to the timeline for a trigger event reflecting the period of elapsed silence and a key sound indicator is applied to the timeline reflecting the key sound; and
presenting user-selectable control options for modifying presentation of the second audio stream, the user-selectable control options implemented by selection of markings on the timeline and playback controls.

10. The computer program product of claim 9, further comprising instructions for implementing:
sending an alert to one of the at least two parties who is identified in the user-defined settings when the trigger event occurs, wherein the modifying presentation of the second audio stream is performed in response to a control option selected as a result of the alert.

11. The computer program product of claim 9, wherein the presentation of the second audio stream is modified by at least one of:
jumping forward or backward between key sound indicators;
speeding up playback of a portion of the second audio stream;
jumping to the end of the second audio stream and rejoining the first audio stream in progress; and
automatically returning to a portion of the second audio stream when a trigger set for the period of elapsed silence has been detected.

12. The computer program product of claim 9, wherein the key sound includes at least one of:
a change of speaker, wherein the speaker represents one of the at least two parties; and
an audio tone.
